(19) United States
(12) Patent Application Publication
(10) Pub. No.: US 2015/0286301 A1
(43) Pub. Date: Oct. 8, 2015

(54) DISPLAY APPARATUS

(71) Applicants: BOE TECHNOLOGY GROUP CO., LTD., Beijing (CN); BEIJING BOE OPTOELECTRONICS TECHNOLOGY CO., LTD., Beijing (CN)

(72) Inventors: Jiuxia Yang, Beijing (CN); Feng Bai, Beijing (CN)

(73) Assignee: BOE TECHNOLOGY GROUP CO., LTD., Beijing (CN)

(21) Appl. No.: 14/389,112

(22) PCT Filed: Dec. 11, 2013
(86) PCT No.: PCT/CN2013/089086

§ 371 Date: Sep. 29, 2014

(30) Foreign Application Priority Data
Aug. 12, 2013 (CN) 201310349023.9

(51) Int. Cl. G06F 3/041; G06F 1/32

(52) U.S. Cl. CPC G06F 3/041; G06F 1/3203

(57) ABSTRACT

The present invention provides a display apparatus comprising a display screen, the display apparatus comprises a main control body and a touch-sensitive unit provided on one side of the main control body, the touch-sensitive unit comprises a touch-sensitive screen, wherein the display apparatus further comprises an auxiliary touch-sensitive unit provided on the other side of the main control body, the main control body is used for controlling the touch-sensitive unit and the auxiliary touch-sensitive unit. The display apparatus has an improved endurance so that an application requiring the display apparatus to be supplied with power for a long time can be achieved.

### TECHNICAL FIELD

The present invention relates to the field of display technology, and particularly, to a display apparatus.

### BACKGROUND ART

With the development of electronic technology industry, more and more digital products enter people's daily life so as to bring a new, comfortable, convenient way of life for the people. Especially, development of intelligent display apparatus with a large screen makes people's life extend in breadth and depth.

However, the higher the intelligent level of a display apparatus, the more the number of built-in instructions is, and the larger the set of instructions is, so that the more the programs running in background are, and the more the power consumed by processor of the display apparatus is. Further, a survey shows that, power consumed by screen of a display apparatus is about or more than 50% of total power consumption of the display apparatus, thus a larger screen for colorful display will lead to more power consumption of the display apparatus with this screen. Currently, although intelligent application functions of a hand-held display apparatus such as telephone, hand-held radio, and electronic player are relatively comprehensive, battery capacity thereof is not increased with the comprehensive of the intelligent application functions, in other words, the development of the battery capacity falls far behind the diversification and complication of the intelligent application functions, so that the hand-held display apparatus such as telephone, hand-held radio and electronic player may be suddenly powered off at a critical moment of usage.

Therefore, at present, a technical problem to be solved is how to control and reduce power consumption of a display apparatus so that a limited battery capacity thereof is effectively used and not wasted, and how to enhance power supply ability of a battery on basis of current battery capacity so as to improve endurance of the display apparatus, so that an application, which requires to supply power to the display apparatus for a long time, can be satisfied.

### SUMMARY

In view of above technical problem, an objective of the present invention is to provide a display apparatus with an improved endurance so that an application requiring the display apparatus to be supplied with power for a long time can be satisfied.

In order to achieve the above objective, the present invention provides a display apparatus with a display screen, which comprises a main control body and a touch-sensitive unit provided on one side of the main control body, the touch-sensitive unit comprises a touch-sensitive screen, wherein the display apparatus further comprises an auxiliary touch-sensitive unit provided on the other side of the main control body, the main control body is used for controlling the touch-sensitive unit and the auxiliary touch-sensitive unit.

The touch-sensitive screen may be provided in the display screen in on-cell, in-cell or OGS mode.

The display apparatus may further comprise a local power supply unit which is electrically connected with the auxiliary touch-sensitive unit to supply power to the auxiliary touch-sensitive unit.

The display apparatus may further comprise a power monitoring module and a battery unit, wherein, when power of the local power supply unit is less than a predetermined power, the auxiliary touch-sensitive unit is switched to be connected with the battery unit so that the auxiliary touch-sensitive unit is powered by the battery unit.

The display apparatus may further comprise a front cover, a side cover and a back cover which fasten together to form a case of the display apparatus, wherein the touch-sensitive unit is provided in the case near the front cover, the auxiliary touch-sensitive unit and the local power supply unit are provided in the case near the back cover, and the main control body is provided in the case, inside the side cover and between the touch-sensitive unit and the auxiliary touch-sensitive, the local power supply unit.

A function key may be provided on the back cover and electrically connected with the auxiliary touch-sensitive unit, wherein the function key may be at least one of music playing key, time broadcasting key, and call answering key.

The auxiliary touch-sensitive unit may extend to a region between the side cover and the main control body, and both the side cover and the back cover may be provided with a function key thereon, wherein the function key is electrically connected with the auxiliary touch-sensitive unit and may be at least one of music playing key, time broadcasting key, and call answering key.

The auxiliary touch-sensitive unit may comprise an auxiliary touch-sensitive screen provided with number keys and sign keys thereon, and a calling key may be provided on the back cover and electrically connected with the auxiliary touch-sensitive unit.

The local power supply unit may be closer to the back cover than the auxiliary touch-sensitive unit.

The local power supply unit may be a solar panel, and a region of the back cover, corresponding to the solar panel, is formed of transparent material, wherein the region of the back cover, formed of transparent material, has an area greater or equal to an area of the solar panel.

The auxiliary touch-sensitive unit may comprise a sensor electrode provided inside the back cover, and the local power supply unit may be provided on one side of the sensor electrode away from the back cover and electrically connected with the sensor electrode.

The auxiliary touch-sensitive unit may further comprise a shielding layer, and the shielding layer and the sensor electrode are provided correspondingly, wherein the shield layer is provided on the side of the sensor electrode away from the back cover and is formed of organic material.

The sensor electrode may be formed of carbon nanotube or graphene material.

The sensor electrode may comprise a first electrode, a second electrode and a dielectric layer provided between the first electrode and the second electrode, wherein the first electrode and the second electrode are separated and are formed of carbon nanotube and tin indium oxide, or carbon nanotube and graphene, respectively, and the dielectric layer is formed of organic material.

The auxiliary touch-sensitive unit may further comprise a substrate, wherein the sensor electrode is provided on one side of the substrate, and the local power supply unit is provided on the other side of the substrate and electrically connected with the sensor electrode; or, both sides of the substrate are provided with the sensor electrode thereon, and the local power supply unit is provided inside the back cover and electrically connected with the sensor electrodes on the both side of the substrate; or, the sensor electrode is provided on one side of the substrate, and the local power supply unit is provided on one side of the sensor electrode away from the substrate and is electrically connected with the sensor electrode.

The auxiliary touch-sensitive unit may further comprise a shielding layer, and the shielding layer and the sensor electrode are provided correspondingly, wherein the shield layer is provided on the side of the sensor electrode away from the substrate and is formed of organic material.

The display apparatus may further comprise an insulating layer provided between the sensor electrode and the local power supply unit.

Advantageous effects of the present invention are as follows.

In the display apparatus of the present invention, by providing the auxiliary touch-sensitive unit, operations of various functions such as music playing, time broadcasting, call answering and even calling are performed by the auxiliary touch-sensitive unit without full lighting the display screen of the display apparatus and the touch-sensitive screen of the touch-sensitive unit, which can significantly reduce power consumption of the display apparatus. In addition, the local power supply unit is provided in the display apparatus of the present invention to supply additional power to the auxiliary touch-sensitive unit so that no or little power of original battery of the display apparatus is consumed. By this way, endurance of the display apparatus is enhanced, and an application, which requires the display apparatus to be supplied with power for a long time, can be achieved.

### BRIEF DESCRIPTION OF THE DRAWINGS

FIG. 1 shows a structure diagram of a display apparatus according to Embodiment 2 of the present invention.

FIG. 2 shows a diagram of formation of an auxiliary touch-sensitive unit and a local power supply unit of the display apparatus according to Embodiment 2 of the present invention.

FIG. 3 shows a distribution diagram of function keys of the display apparatus according to Embodiment 2 of the present invention.

FIG. 4 shows a formation diagram of an auxiliary touch-sensitive unit and a local power supply unit of a display apparatus according to Embodiment 3 of the present invention.

FIG. 5 shows a formation diagram of an auxiliary touch-sensitive unit and a local power supply unit of the display apparatus according to Embodiment 3 of the present invention.

FIG. 6 shows a distribution diagram of function keys of a display apparatus according to Embodiment 7 of the present invention.

### REFERENCE SIGNS

1—front cover; 2—-touch-sensitive unit; 3—main control body; 4—auxiliary touch-sensitive unit; 41—substrate; 42—sensor electrode; 43—insulating layer; 44—shielding layer; 45—auxiliary touch-sensitive screen; 5—local power supply unit; 6—side cover; 7—back cover; 81—-music playing key; 82—time broadcasting key; 83—call answering key; 84—calling key.

### DETAILED DESCRIPTION OF THE PREFERRED EMBODIMENTS

In order to make skilled persons in the art better understand the technical solutions of the present invention, the present invention will be described in detail below with reference to the drawings and specific embodiments.

### Embodiment 1

The present embodiment provides a display apparatus with a display screen, which comprises a main control body and a touch-sensitive unit provided on one side of the main control body, the touch-sensitive unit comprises a touch-sensitive screen, wherein the display apparatus further comprises an auxiliary touch-sensitive unit provided on the other side of the main control body, the main control body is used for controlling the touch-sensitive unit and the auxiliary touch-sensitive unit.

A part of functions of the display apparatus can be performed by the auxiliary touch-sensitive unit when a user touches the auxiliary touch-sensitive unit. For example, the functions performed by the auxiliary touch-sensitive unit may be functions that need not to provide the user with screen displaying with a large size, a high brightness, a high contrast or multiple colors etc., which will result in high power consumption. To take a telephone as an example of the display apparatus, the auxiliary touch-sensitive unit may have a calling function. When a user makes a telephone call and communicates by telephone through the auxiliary touch-sensitive unit, it only need to activate the auxiliary touch-sensitive unit with little power consumption without lighting the display screen or touch-sensitive screen of the display apparatus, thereby power consumption of the display apparatus is reduced significantly.

The auxiliary touch-sensitive unit may comprise an auxiliary touch-sensitive screen provided with number keys, sign keys and function keys etc. thereon. Alternatively, the function keys (such as dialing keys) may be implemented by mechanical keys.

### Embodiment 2

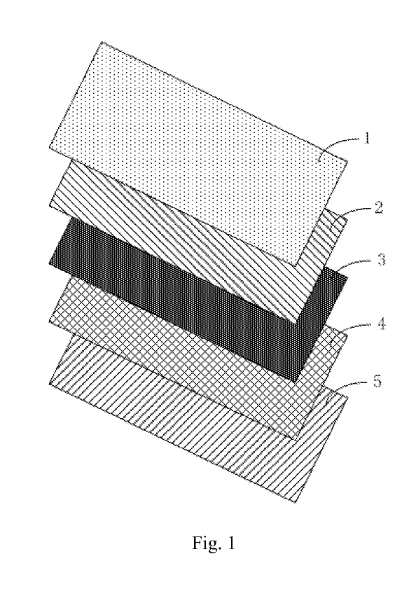

The present embodiment provides a display apparatus with a display screen, the display apparatus comprises a front cover, a side cover and a back cover which are fit and can be fastened together with each other. As shown in FIG. 1, a front cover 1, a side cover (not shown in FIG. 1) and a back cover (not shown in FIG. 1) are fastened together to form a case of the display apparatus. In the case of the display apparatus, a touch-sensitive unit 2, a main control body 3, an auxiliary touch-sensitive unit 4 and a local power supply unit 5 are provided sequentially from top to bottom, and the local power supply unit 5 is electrically connected with the auxiliary touch-sensitive unit 4 to supply power to the auxiliary touch-sensitive unit 4.

Specifically, the touch-sensitive unit 2 is provided inside the front cover 1 and comprises a touch-sensitive screen. The touch-sensitive screen and the display screen of the display apparatus may be integrated as a whole or provided separately, which is not limited here, as long as touch and display functions can be performed. The main control body 3 is provided inside the side cover and is necessary for touch, display and other functions of the display apparatus. For example, to take a telephone as an example of the display apparatus in the present embodiment, the main control body 3 comprises a communication module used for calling, call answering, sending messages and receiving messages and the corresponding circuits, and a frequency radio module provided for ensuring communication ability and a frequency radio antenna connected with the frequency radio module. The auxiliary touch-sensitive unit 4 and the local power supply unit 5 are provided inside the back cover, and the local power supply unit 5 may be closer to the back cover than the auxiliary touch-sensitive unit 4. In the present embodiment, the main control body 3 is used for controlling the touch-sensitive unit 2 to perform touch and display functions and controlling the auxiliary touch-sensitive unit 4 to perform a touch function, and the local power supply unit 5 is electrically connected with the auxiliary touch-sensitive unit 4 to supply power to the auxiliary touch-sensitive unit 4.

The local power supply unit 5 may be a solar panel (also called as photovoltaic battery) formed by a semiconductor process, and a region of the back cover, corresponding to the solar panel, is formed of transparent material, wherein the region of the back cover, formed of transparent material, has an area greater or equal to an area of the solar panel so that the solar panel is irradiated by sufficient light and solar power can be converted into electrical power as much as possible.

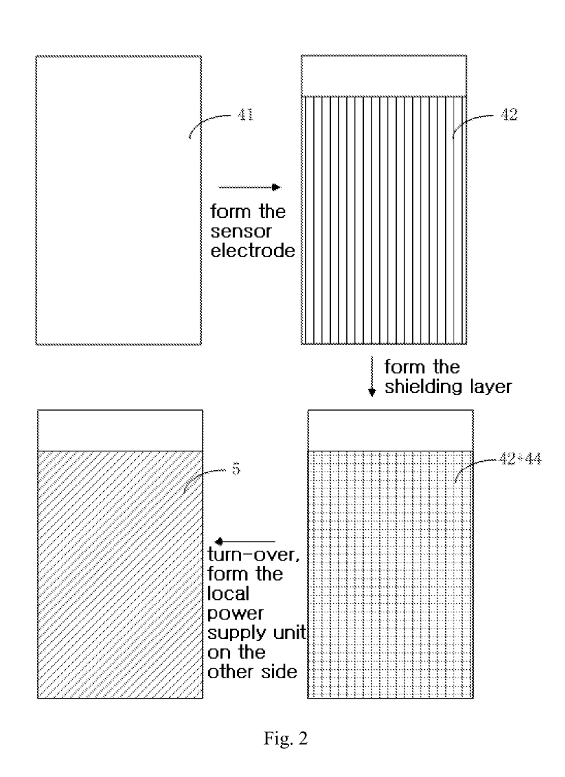

In the present embodiment, as shown in FIG. 2, the auxiliary touch-sensitive unit 4 comprises a substrate 41 and a sensor electrode 42 provided on one side of the substrate 41, and the local power supply unit 5 is provided on the other side of the substrate 41 and electrically connected with the sensor electrode 42. In order to obtain stable touch signals, in the auxiliary touch-sensitive unit 4, a shielding layer 44 is further provided on one side of the sensor electrode 42 away from the substrate 41, wherein the shielding layer 44 and the sensor electrode 42 are provided correspondingly and the shielding layer 44 is formed of organic material. Here, it should be understood that, it is enough to provide the auxiliary touch-sensitive unit and the local power supply unit inside the back cover, that is, whether the sensor electrode or the local power supply unit is relatively closer to the back cover, or the sensor electrode and the local power supply unit are provided in a mixed manner, a good touch effect of the auxiliary touch-sensitive unit can be achieved and a good power supply from the local power supply unit to the auxiliary touch-sensitive unit can be achieved.

The sensor electrode 42 may be formed of carbon nanotube by a drawing process or formed of graphene material by a patterning process. As shown in FIG. 2, in the present embodiment, the formation procedure of the auxiliary touch-sensitive unit and the local power supply unit is as follows: first, applying curing material on one side of the substrate 41, and making a part of dissolvent in the curing material volatilize by pre-drying, then forming the sensor electrode 42 with the curing material by a drawing process, and forming the shielding layer 44 on the sensor electrode 42; turning over the substrate 41 to form the local power supply unit 5 on the other side of the substrate 41, for example, to form a solar panel by a semiconductor process. In the diagram of FIG. 2, the area of the sensor electrode 42 is relatively large and almost covers the back cover except the region used for providing an antenna and a camera (i.e., the region above the substrate 41 with no pattern provided thereon in FIG. 2). During the formation, the shape, area and position of the sensor electrode may be adjusted appropriately according to a circuit design of the display apparatus or shapes, sizes and positions of the function keys, so that a good touch effect and a low producing cost can be obtained simultaneously.

In the present embodiment, as carbon nanotube and graphene material are all suitable for flexible display, correspondingly, the substrate 41 may be suitable for flexible display, so that the auxiliary touch-sensitive unit 4 may extends to a region between the side cover and the main control body 3. Moreover, there may be function keys provided on the side cover and the back cover and electrically connected with the auxiliary touch-sensitive unit 4. The function keys include various function keys such as music playing key, time broadcasting key, call answering key or the like. The function keys may be provided on the outer side of the back cover of the display apparatus or outer side of the side cover of the display apparatus, and may be one or more, wherein one function key may only has one function or one function key have more than one functions.

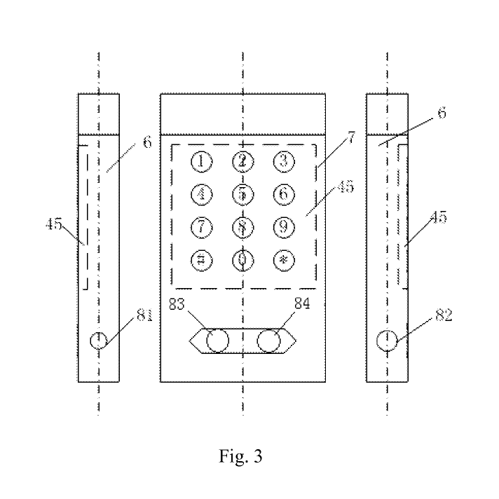

FIG. 3 shows a distribution diagram of function keys of the display apparatus according to Embodiment 2 of the present invention. As shown in FIG. 3, for example, the display apparatus is a telephone, wherein a music playing key 81 and a time broadcasting key 82 are provided on outer sides of the left and right side cover 6 respectively, a call answering key 83 is provided on the outer side of the back cover 7, and each function key operates in a predefined operation mode to achieve a function corresponding thereto. The auxiliary touch-sensitive unit 4 may be provided with an auxiliary touch-sensitive screen 45 provided with number keys and sign keys therein, and achieving a touch function thereof by the sensor electrode 42. A calling key 84 may be further provided on the outer side of the back cover 7 and electrically connected with the auxiliary touch-sensitive unit 4 to achieve a calling function by the auxiliary touch-sensitive unit 4. The auxiliary touch-sensitive screen 45 may be embedded in the back cover 7, or may be formed by forming the part of the back cover 7 corresponding to the auxiliary touch-sensitive screen 45 with transparent material, which is not limited here, as long as the corresponding function can be achieved. The auxiliary touch-sensitive screen 45 may be a transparent substrate formed of material such as glass or plastic. The number keys and sign keys in the auxiliary touch-sensitive screen 45 may be virtual keys capable of being operated with no requirement for being lighted, or keys capable of being operated with a requirement for being locally lighted. Compared to the display screen and the touch-sensitive screen, the auxiliary touch-sensitive screen 45 is only used for operation of number keys and sign keys. As there is no need for full lighting the display screen and the touch-sensitive screen, a calling function can be achieved by using a relatively little power. Similarly, a music playing function, a time broadcasting function and a call answering function also can be achieved by the auxiliary touch-sensitive unit 4 with a relatively little power without lighting the display screen and the touch-sensitive screen.

In the present embodiment, the display apparatus further comprises a battery unit and a power monitoring module. When power of the local power supply unit (e.g., a solar panel) 5 is less than a predetermined power, the auxiliary touch-sensitive unit 4 is switched to be connected with the battery unit so that the auxiliary touch-sensitive unit is powered by the battery unit. For example, the auxiliary touch-sensitive unit 4 may be simultaneously connected with the battery unit and the local power supply unit in advance, but first is powered by the local power supply unit 5. When the power of the local power supply unit 5 is insufficient, for example, when the power of the local power supply unit 5 is 30% of nominal operation power of the auxiliary touch-sensitive unit 4, the auxiliary touch-sensitive unit 4 is switched to be powered by the battery unit.

In the display apparatus of the present embodiment, the touch-sensitive screen of the touch-sensitive unit may be provided in the display screen of the display apparatus in on-cell, in-cell or OGS (One Glass Solution) mode, and the display screen may be a LCD screen or an OLED screen. Moreover, the display apparatus may be any product or component with touch and display function, such as a hand-held radio, an electronic player, a liquid crystal display, an e-book, an OLED display, a tablet, a digital photo frame and so on. The invention is especially applicable to the hand-held display device.

### Embodiment 3

The difference between the present embodiment and Embodiment 2 is that, relative position between the auxiliary touch-sensitive unit and the local power supply unit is changed.

In the present embodiment, the auxiliary touch-sensitive unit 4 comprises a substrate 41, a sensor electrode 42 and an insulating layer 43, wherein the sensor electrode 42 and the insulating layer 43 are sequentially provided on one side of the substrate 41, and a local power supply unit 5 is provided on one side of the insulating layer 43 away from the substrate 41 and electrically connected with the sensor electrode 42. Further, a shielding layer 44 is provided on one side of the local power supply unit 5 away from the substrate 41.

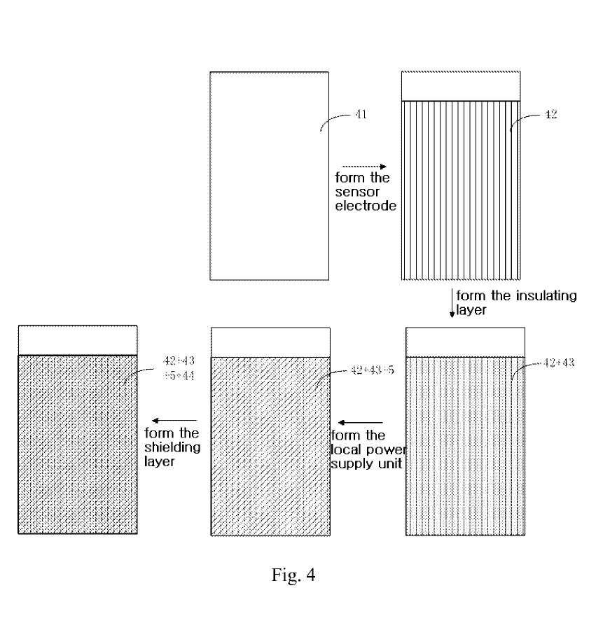

As shown in FIG. 4, in the present embodiment, the formation procedure of the auxiliary touch-sensitive unit 4 and the local power supply unit 5 is as follows: first, forming a sensor electrode 42 on one side of the substrate 41, and forming the insulating layer 43 on the sensor electrode 42, then forming a local power supply unit 5 on the insulating layer 43, and forming a shielding layer 44 on the local power supply unit 5, wherein the insulating layer 43 and the shielding layer 44 are formed of organic material, the insulating layer 43 is formed so that the sensor electrode 42 and the local power supply unit 5 are well separated, and the shielding layer 44 is formed to shield external electromagnetic interference so that the auxiliary touch-sensitive unit 4 has a higher touch sensitivity. Of course, in above configuration, the shielding layer 44 also can be provided on one side of the insulating layer 43 away from the substrate 41, and at this time, to some extent, the shielding layer 44 and the insulating layer 43 can be regarded as one layer with double function of simultaneously insulating and shielding electromagnetic interference.

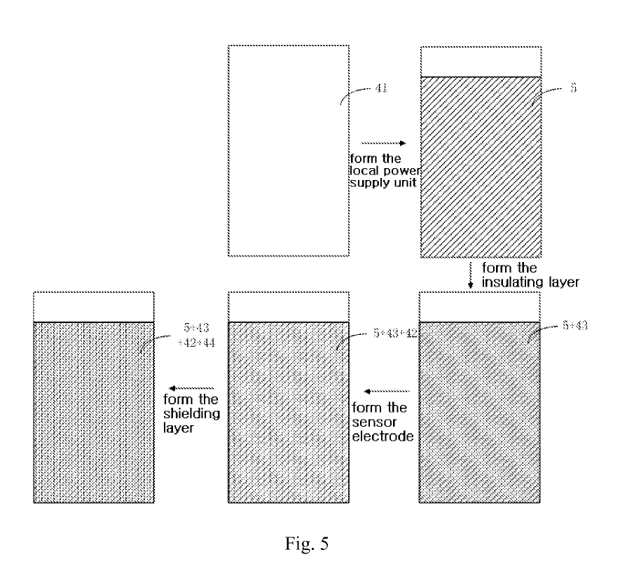

It should be understood that, the auxiliary touch-sensitive unit 4 and the local power supply unit 5 may be provided so that the substrate 41, the local power supply unit 5, the insulating layer 43, the sensor electrode 42 and the shielding layer 44 are sequentially provided, as shown in FIG. 5. Alternatively, the auxiliary touch-sensitive unit 4 and the local power supply unit 5 may be provided so that the substrate 41, the local power supply unit 5, the insulating layer 43 and the sensor electrode 42 are sequentially provided, and the shielding layer 44 is provided on the other side of the substrate 41. In fact, position of the shielding layer 44 may be changed in accordance with position of the sensor electrode 42 of the auxiliary touch-sensitive unit 4, as long as a corresponding shielding function can be achieved.

Other configurations of the display apparatus of the present embodiment are the same as that in Embodiment 2, which will not be repeatedly described here.

### Embodiment 4

The difference between the present embodiment and Embodiment 3 is that, in the present embodiment, the touch-sensitive unit does not comprise a substrate.

In the present embodiment, the sensor electrode 42 of the auxiliary touch-sensitive unit 4 is provided inside the back cover 7, and the local power supply unit 5 is provided on one side of the sensor electrode 42 away from the back cover 7 and electrically connected with the sensor electrode 42. The auxiliary touch-sensitive unit 4 may further comprise an insulating layer 43 and a shielding layer 44, wherein the insulating layer 43 is provided between the sensor electrode 42 and the local power supply unit 5, the shielding layer 44 and the sensor electrode 42 are correspondingly provided and the shielding layer 44 is provided on the side of the sensor electrode 42 away from the back cover 7, and the insulating layer 43 and the shielding layer 44 are formed of organic material.

Other configurations of the display apparatus of the present embodiment are the same as that in Embodiment 3, which will not be repeatedly described here.

Compared to Embodiment 3, the back cover 7 in the present embodiment is equivalent to a combination of the substrate and the back cover in Embodiment 3. As the number of components is reduced in the present embodiment, the display apparatus of the present embodiment has a simpler structure, resulting that it is easy to assemble the display apparatus and cost of the display apparatus is reduced.

### Embodiment 5

The difference between the present embodiment and Embodiment 2 or 3 is that, in the display apparatus of the present embodiment, the auxiliary touch-sensitive unit and the local power supply unit are separately provided, and the local power supply unit is attached to and provided on the back cover.

In the present embodiment, both sides of the substrate 41 of the auxiliary touch-sensitive unit 4 are provided with the sensor electrode 42 thereon, and the local power supply unit 5 is provided inside the back cover 7 and electrically connected with the sensor electrodes 41 on the both sides of the substrate 41.

Other configurations of the display apparatus of the present embodiment are the same as that in Embodiment 2 or 3, which will not be repeatedly described here.

### Embodiment 6

The difference between the present embodiment and any one of Embodiments 2 to 5 is that, the structure of the sensor electrode is changed.

In the present embodiment, the sensor electrode 42 comprises a first electrode and a second electrode and a dielectric layer provided between the first electrode and the second electrode, wherein the first electrode and the second electrode are separated and are formed of carbon nanotube and tin indium oxide, or carbon nanotube and graphene, respectively, and the dielectric layer is formed of organic material.

Other configurations of the display apparatus of the present embodiment are the same as that in any one of Embodiments 2 to 5, which will not be repeatedly described here.

### Embodiment 7

The difference between the present embodiment and any one of Embodiments 2 to 6 is that, in the present embodiment, the auxiliary touch-sensitive unit does not comprise an auxiliary touch-sensitive screen.

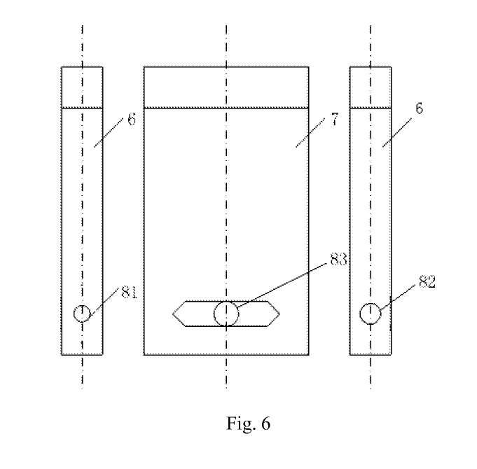

In the present embodiment, as there is no auxiliary touch-sensitive screen, correspondingly, as shown in FIG. 6, for example, when the display apparatus is a telephone, only a music playing key 81, a time broadcasting key 82 and a call answering key 83 are provided on the back cover 7 and the side cover 6 and electrically connected with the auxiliary touch-sensitive unit to achieve corresponding functions by the auxiliary touch-sensitive unit. In the present embodiment, when dialing a phone number, as the display screen of the display apparatus and/or the touch-sensitive screen of the touch-sensitive unit, and the number keys, sign keys and function keys therein will be used, the display screen of the display apparatus and/or the touch-sensitive screen should be full lighted. Of course, when there is no auxiliary touch-sensitive screen, the number keys, the sign keys or the like may be provided as virtual keys or entity keys in the auxiliary touch-sensitive unit 4, when virtual keys are provided, a manner that the keys which are touched are lighted and the keys which are not touched are not lighted or partially lighted may be employed. It should be understood that, whether the auxiliary touch-sensitive unit comprises an auxiliary touch-sensitive screen, function of the auxiliary touch-sensitive unit will not be affected. However, as the auxiliary touch-sensitive screen is omitted, compared to the display apparatus of any one of Embodiments 2 to 6, the display apparatus of the present embodiment has a reduced cost.

Other configurations of the display apparatus of the present embodiment are the same as that in any one of Embodiments 2 to 6, which will not be repeatedly described here.

In the display apparatus of Embodiments 1 to 7, as there are an auxiliary touch-sensitive unit and a local power supply unit provided inside the back cover of the display apparatus, various functions such as music playing, time broadcasting, call answering and even calling or the like can be achieved without full lighting the display screen of the display apparatus and the touch-sensitive screen of the touch-sensitive unit, therefore power consumption of the display apparatus is reduced and endurance of the display apparatus is enhanced, thereby an application, which requires the display apparatus to be supplied with power for a long time, can be achieved.

It should be understood that, the above implementations are only used to explain the principle of the present invention, but not to limit the present invention. Some technical features of the above may be omitted from the embodiments of the present invention so as to only solve a part of the technical problems existing in the prior art, and the disclosed technical features may be combined in an arbitrary way. The person skilled in the art can make various variations and modifications without departing from the spirit and scope of the present invention, and the variations and modifications fall into the scope of the present invention. The protection scope of the present invention should be defined by the claims.

1. A display apparatus with a display screen, which comprises a main control body and a touch-sensitive unit provided on one side of the main control body, the touch-sensitive unit comprises a touch-sensitive screen, wherein the display apparatus further comprises an auxiliary touch-sensitive unit provided on the other side of the main control body, the main control body is used for controlling the touch-sensitive unit and the auxiliary touch-sensitive unit.

2. The display apparatus of claim 1, wherein the touch-sensitive screen is provided in the display screen in on-cell, in-cell or OGS mode.

3. The display apparatus of claim 1, further comprising a local power supply unit which is electrically connected with the auxiliary touch-sensitive unit to supply power to the auxiliary touch-sensitive unit.

4. The display apparatus of claim 1, further comprising a power monitoring module and a battery unit, wherein, when power of the local power supply unit is less than a predetermined power, the auxiliary touch-sensitive unit is switched to be connected with the battery unit so that the auxiliary touch-sensitive unit is powered by the battery unit.

5. The display apparatus of claim 3, further comprising a front cover, a side cover and a back cover which fasten together to form a case of the display apparatus, wherein the touch-sensitive unit is provided in the case near the front cover, the auxiliary touch-sensitive unit and the local power supply unit are provided in the case near the back cover, and the main control body is provided in the case inside the side cover and between the touch-sensitive unit and the auxiliary touch-sensitive, the local power supply unit.

6. The display apparatus of claim 5, wherein a function key is provided on the back cover and electrically connected with the auxiliary touch-sensitive unit, wherein the function key comprises at least one of music playing key, time broadcasting key, and call answering key.

7. The display apparatus of claim 5, wherein the auxiliary touch-sensitive unit extends to a region between the side cover and the main control body, and both the side cover and the back cover are provided with a function key thereon, wherein the function key is electrically connected with the auxiliary touch-sensitive unit and comprises at least one of music playing key, time broadcasting key, and call answering key.

8. The display apparatus of claim 5, wherein the auxiliary touch-sensitive unit comprises an auxiliary touch-sensitive screen provided with number keys and sign keys thereon, and a calling key is provided on the back cover and electrically connected with the auxiliary touch-sensitive unit.

9. The display apparatus of claim 5, wherein the local power supply unit is closer to the back cover than the auxiliary touch-sensitive unit.

10. The display apparatus of claim 9, wherein the local power supply unit is a solar panel, a region of the back cover, corresponding to the solar panel, is formed of transparent material, wherein the region of the back cover, formed of transparent material, has an area greater or equal to an area of the solar panel.

11. The display apparatus of claim 5, wherein the auxiliary touch-sensitive unit comprises a sensor electrode.

12. The display apparatus of claim 11, wherein the sensor electrode is provided inside the back cover, and the local power supply unit is provided on one side of the sensor electrode away from the back cover and electrically connected with the sensor electrode.

13. The display apparatus of claim 12, wherein the auxiliary touch-sensitive unit further comprises a shielding layer, and the shielding layer and the sensor electrode are provided correspondingly, wherein the shield layer is provided on the side of the sensor electrode away from the back cover and is formed of organic material.

14. The display apparatus of claim 12, further comprises an insulating layer provided between the sensor electrode and the local power supply unit.

15. The display apparatus of claim 11, wherein the sensor electrode is formed of carbon nanotube or graphene material.

16. The display apparatus of claim 11, wherein the sensor electrode comprises a first electrode, a second electrode and a dielectric layer provided between the first electrode and the second electrode, wherein the first electrode and the second electrode are separated and are formed of carbon nanotube and tin indium oxide, or carbon nanotube and graphene, respectively, and the dielectric layer is formed of organic material.

17. The display apparatus of claim 11, wherein the auxiliary touch-sensitive unit further comprises a substrate.

18. The display apparatus of claim 17, wherein the sensor electrode is provided on one side of the substrate, and the local power supply unit is provided on the other side of the substrate and electrically connected with the sensor electrode;
or, both sides of the substrate are provided with the sensor electrode thereon, and the local power supply unit is provided inside the back cover and electrically connected with the sensor electrodes on the both side of the substrate;
or, the sensor electrode is provided on one side of the substrate, and the local power supply unit is provided on one side of the sensor electrode away from the substrate and is electrically connected with the sensor electrode.

19. The display apparatus of claim 18, wherein the auxiliary touch-sensitive unit further comprises a shielding layer, and the shielding layer and the sensor electrode are provided correspondingly, wherein the shield layer is provided on the side of the sensor electrode away from the substrate and is formed of organic material.

20. The display apparatus of claim 18, further comprises an insulating layer provided between the sensor electrode and the local power supply unit.
